(19) United States
(12) Patent Application Publication
(10) Pub. No.: US 2001/0040935 A1
(43) Pub. Date: Nov. 15, 2001

(54) Commercial power production by catalytic fusion of deuterium gas

(76) Inventor: Leslie catron Case, Newfields, NH (US)

Correspondence Address: Leslie C. Case, 152 Piscassic Road, Newfields, NH, 03856, US

(21) Appl. No.: 09/790,153

(22) Filed: Feb. 21, 2001

Related U.S. Application Data
(63) Continuation-in-part of application No. 07/713,302, filed on Jun. 11, 1991, now abandoned.
(63) Continuation-in-part of application No. 07/749,149, filed on Aug. 23, 1991, now abandoned.
(63) Continuation-in-part of application No. 07/830,718, filed on Feb. 4, 1992, now abandoned.
(63) Continuation-in-part of application No. 08/135,021, filed on Oct. 13, 1993, now abandoned.
(63) Continuation-in-part of application No. 08/188,948, filed on Jan. 27, 1994, now abandoned.
(63) Continuation-in-part of application No. 08/262,777, filed on Jun. 20, 1994, now abandoned.
(63) Continuation-in-part of application No. 08/459,763, filed on Jun. 2, 1995, now abandoned.
(63) Continuation-in-part of application No. 08/644,118, filed on May 10, 1996, now abandoned.

(51) Int. Cl. G21J 1/00; G21B 1/00

(52) U.S. Cl. 376/100

(57) ABSTRACT

After much experimentation, I have developed, a new, cost-effective, process for commercial-scale production of power by catalytic fusion of D₂ gas, under moderate conditions of temperature and pressure. This process can be scaled up to any desired size, and can employ a variety of “hydrogenation” catalysts, both precious metal, and non-precious metal. Briefly, the process comprises absorbing D₂ gas in or on the selected catalyst, then bringing the temperature into the range of very roughly 150° to 250° C., and then degassing the catalyst bed under reduced pressure.

The process is necessarily run on a cyclic basis, with a multiplicity of catalyst bed entities, with one or more being in the D₂-absorption mode, concurrently with one or more being in the heat-generation node.

### BACKGROUND OF THE INVENTION

Since about the 1920's, it has been known that the deuterium nucleus is unusually massive, compared to its neighbors in the periodic table. Because it has also been recognized for about the same length of time that e=mC², the thought has been kicking around for decades that this excess mass is a potential source of energy, provided that the deuterium nucleus can be converted into some other nucleus, the obvious choice being helium-4, which is very stable, and has a very low mass. Thus, theoretically, if 2 deuterium nucleii can be fused into one helium-4, almost 24 million electron volts are generated, and there is enough deuterium in the heavy water in the oceans to satisfy the, earth's energy needs for hundreds of millions of years.

In about 1989, Pons and Fleishman made the (premature) announcement that they had been able to tap into this source of energy, by electrolyzing heavy water (D₂O), in the presence of palladium. Quite a bit of experimentation has been conducted on this process since that time, and it remains highly controversial, yielding only very low, and arguably zero, output. The instant inventor believes that their reported effect is real, and is due to the generation of charged deuterium nucleii in tho electrolysis, which can combine to a very small extent to helium, provided that the metal in contact with the electrolyte is catalytic in nature. This necessity for catalytic properties has generally not been recognized, nor have appropriate experiments been published.

Thus, as of April, 1998, the status on fusion of deuterium into helium was:

1) Electrolysis effects were generally very small, at best, and highly unreproducible.

2) Concurrently, “big” science, funded by billions of public dollars, was pursuing hot, plasma fusion of deuterium, with clearly demonstrated success, but in such small amounts, and at such a cost in equipment and energy expended, as to be totally worthless for scale-up to commercial power production.

3) Also, concurrently, the “hot” fusion crowd (for personal gain), and other know-it-all so-called “scientests” conducted a propaganda barrage, denigrating the possibility of fusion of deuterium under moderate conditions. That barrage continues to this day, with some so-called “expert” being quoted, in the press once in awhile, to the extent that “cold-fusion” is hot air, and bad science.

This all started to change in April, 1993, when the instant inventor announced at the Vancouver, ICCF VII, meeting that D₂ gas could be fused into helium, when contacted with a palladium-on-carbon catalyst, at moderately elevated pressure and temperature. Since that announcement, a number of investigators have attempted to reproduce the effect. Some such investigators have failed to so reproduce, and have rather publically denounced catalytic fusion as more bad science. It should be noted, however, that these negatively-leaning investigators changed the conditions of the experiment, and blithely ignored that if you change the conditions, you will not necessarily obtain the same results.

There have been publically announced confirmations of the said announced catalytic-fusion effect. Notable among these, the group at SRI has announced apparent heat effects, and found, a measured helium-4 content rising to 10 parts per million, and above. Insofar as the helium content of air is only 5 parts per million, a yield of 10 parts per million is significant. And the instant inventor has heard unofficial reports of detection of helium-3, the presence of which would be a definitive confirmation of some sort of fusion.

But, problems remained, and at the time of the present invention, the situation was:

1) The catalytic fusion effect was small, and was absolutely dependent on the configuration and operation of the apparatus. Any change in configuration would likely result in a null effect.

The best estimate of the configuration effect was that some sort of gradient in D₂ concentration had to be present in the catalyst, due to flow, or convection, or other mechanism.

2) The process could not be scaled up. In the instant inventor's experiments, use of larger amounts of catalyst in the same equipment tended to kill the exotherm.

3) Very importantly, the process demanded on the use of a palladium, or other platinum-group metal, catalyst. The cost and unavailability of such metals precludes very large-scale use.

### OUTLINE OF THE INVENTION

There are two essential components which, taken together, are the basis of the present invention:

1) The mass of catalyst (such as in a bed) is first loaded with deuterium gas (generally at a pressure of greater than one atmosphere), and then degassed by lowering the pressure thereabove to much less than one atmosphere absolute. This pressure lowering of the catalyst then results in a substantial temperature exotherm, caused by fusion of deuterium nuclei. Because the pressure may be almost entirely uniformly lowered throughout the catalyst bed, the mass of catalyst is not limited by some necessary configuration, and may be of whatever size or extent as may be desired, to produce whatever power output as may be desired.

2) Because the effects of the lowered pressure, in the degassing step, are so dominant and much greater than those caused previously by configuration alone, a much wider range of catalysts may be employed here, in comparison to the palladium-on-carbon catalysts which were so preferred, or even essential, in the previous process. It appears that here, in order to be active, it may be generally stated that a catalyst must only be a metallic hydrogenation catalyst, which binds deuterium strongly enough at about 150° C., that the bound deuterium is only slowly evolved when subjected to degassing. Stated in conventional terms, the catalyst must chemisorb the deuterium gas at a temperature of about 150° C., and higher.

The platinum-group-metal on carbon catalysts are still of use here, but a wide range of non-platinum-group-metal catalysts are also of use. Perhaps nickel hydrogenation catalysts, such as are widely used in the chemical process industry, are of the widest utility. But it also appears that other metallic catalysts, such as cobalt, copper-chromite, copper, and even iron catalysts can be used. Of course, specialty catalysts, such as rhenium, may also be employed.

The substrates used can vary widely, and may be activated carbon, but may also be silica, alumina, ceramic, and so forth. Indeed, Raney nickel, cobalt, and iron, having no substrate at all, may be employed. And the loading of the metal on the substrate can range from about 3 to 5% by weight, up to about 70%, or more.

Related to the degassing step in 1), above, is the necessity of operating the process in a cyclic fashion, wherein there is a multiplicity of independent catalyst beds, and in which one or more such are in the heat-generating (degassing) step, while one or more such are in the D₂-loading step. This combination makes possible a continuous generation of power, rather than only a batchwise such.

The vessels suitable for use in this invention are not of critical configuration, but generally must be gas-tight, traversed with steam tubes in contact with the catalyst beds, and fitted with gas inlet and outlet ports, and a pump or pumps for filling with D₂, and for degassing. The vessels may be conveniently made of 304 stainless steel, which fabricates well, and is not affected by hydrogen. Other metals of construction may also be employed.

### DETAILED DESCRIPTION OF THE INVENTION

1. Procedure

The basis of this invention is the finding that evacuation of an active hydrogenation catalyst, previously loaded with deuterium gas, at elevated temperature of at least about 150° C. causes fusion of deuterium into helium-4, with consequent release of heat. (The mass of helium-4 is almost 1% less than that of 2 deuterons, and the calculated energy release is 24 meV.). The lowered pressure is maintained by evacuation, as the catalyst is degassed. The exotherm is smooth, with no indication of thermal runaway, and continues for a period of some hours (until degassing is more-or-less complete, and then declines, frequently after about 10 hours or more of degassing.)

When only one unit of catalyst bed is employed, this is a batch process, useful only for intermittent production of heat. In the commercial embodiment, a multiplicity of independent catalyst entities are employed, with one or more in the heat-producing mode, while at the same time, one or more are in the D₂-loading mode. And the systems is set up so that the D₂ gas being evacuated from a degassing unit is not discarded, but is actually pumped into a unit under D₂ loading. Because the catalyst beds are rather compact, with relatively little free gas space, and because the D₂-loading pressures are rather low, frequently in the range of 1 to 10 (and preferably 1 to 5) atm. absolute, the ratio of D₂ to catalyst is kept at a minimum. Thus, the D₂ fuel gas is recycled back and forth between catalyst bed units, the amount being pumped is kept small, and theoretically (barring leaks) there is no D₂ loss.

The resultant process thus operates on a well-defined, closed, cyclic process. The output level is dependent on the operating (degassing) pressure, so this closed, cyclic process also has a variable power output, in between the large steps generated by bringing an additional unit into degassing.

The individual catalyst unit simply comprises a large quantity of catalyst loosely filled (not packed) into a sealed, gas-tight, insulated containing vessel (typically of dewar-type construction, although other high-quality insulation may be used). Because the D₂ gas is highly mobile, it penetrates the catalyst bed through interstices between catalyst particles easily under only slight pressure gradients, thus ensuring even distribution of the D₂ at almost uniform pressure at any given time.

The temperature of degassing is in the range of about 150° C., to about 250° C., or sometimes up to 300°, or even 350° C. The higher temperatures give faster degassing, and larger exotherms, as well as translating into higher efficiencies in the steam turbines, used to generate electricity. However, these higher temperatures also lead to shorter degassing cycles, and greater heat loss from the containing vessel. Also, at about 250° C. and higher, it becomes increasingly difficult to maintain proper insulation capacity in a dewar vessel.

The temperature of loading of the D₂ gas could be at any level between ambient, and the temperature of degassing. However, if the temperature of the catalyst bed is lowered before loading, the temperature must be raised again upon degassing. This up-and-down temperature profile is wasting of heat, and is not preferred. Thus, loading may be preferably be performed at the same temperature of degassing. Also, the loading is performed more quickly, the higher the temperature.

The pressure of degassing is from about 0.25 atm. absolute, or less. Higher pressures give only a small exotherm. And the higher exotherms are obtained at degassing pressures of about 0.1 atm. absolute, or less. Even lower degassing pressures of less than 0.05 atm. absolute may be advantageously employed. It seems that the minimum degassing pressure is determined by the amount of catalyst being degassed, and the efficiency of the vacuum pump. Thus, there is no theoretical lower limit to degassing pressure. The lower the pressure, in general the larger the exotherm.

The catalyst bed is traversed by a multiplicity of steam tubes, spaced so that no part of the catalyst bed is thermally remote from one or more steam tubes. The heat produced by the catalyst bed is thus removed as generated, by the production of steam, which in turn may be run through turbines to produce electricity, or otherwise employed, to apply heat directly.

2. Catalyst

The nature of the active catalyst useful in this process is critical to the success thereof. Very unexpectedly, in view of the experiences of previous investigators, who found it quite difficult to obtain even very small, but consistent, positive temperature effects from deuterium fusion, this procedure easily yields large heat effects with a wide variety of catalysts (not just carefully selected, and very expensive, precious-metal catalysts). With the generality of active catalysts (and not just the carefully selected platinum-group metals) the process can clearly and unequivocally be denoted CATALYTIC FUSION.

Of course, platinum-group metal (PGM) catalysts may still be used, and may indeed still yield the largest beat effects. But no longer is it necessary to use only the previously useful PGM-On-activated carbon (still very useful, but prohibitively expensive and in limited supply—only about 10 to 15 million oundes of PGMs are mined each year, and with other critically important uses thereof burgeoning and demanding of supply). Pd, Pt, Rh, and Ir on activated carbon (at about 0.5% loading) have all been found previously to be effective. Different substrates, and lower loadings, can now be usefully employed. But such uses seem to dead-end on the extremely high price and limited supply of the PGMs.

Although not exclusively useful, nickel hydrogenation catalysts now seem to be preferred. Nickel has long been known as a preferred hydrogenation metal catalyst. It remains so here. It is cheap, about $2.50 per pound, and not in short supply, with a yearly mined production of more than 2 million tons, and with the known reserves easily supporting increased production on demand.

The useful nickel catalysts include nickel on kieselguhr (silica), frequently at 50 to 65% loading, nickel or alumina (at about 20 to 60% metal loading on support), and nickel on ceramic (loadings down to 5 to 10% by weight). Raney nickel may also be usefully employed, although the complications of preparing and using the same, especially at large volume, are definite negatives.

Other of the know hydrogenation catalysts may also be useful, although maybe not preferred over the very useful nickel. Such others include copper chromite, copper, and even iron. The iron catalysts may be especially preferred where found active, because of the unlimited availability and very low cost.

The requisite characteristics of the useful catalysts may be defined as “a metal-containing medium, stable in hydrogen to at least about 250° C., and which chemisorbs deuterium gas at about 150° C.” Here, chemisorption is used in the long-established sense that the medium takes up some D₂ when exposed thereto, and only slowly (not immediately) devolves that D₂ when subjected to a very low pressure (that is, a vacuum).

The theoretical basis, to which I do not wish to be bound, is that the metallic medium strongly binds the D₂, either on the surface, or in the interior crystalline lattice, as deuteron nuclei, not as monoatomic deuterium. When a vacuum is pulled, the deuteron nuclei are forced to move toward escape, and these mobile nuclei are catalytically transformed into helium, a small proportion of the time, through some not understood quantum-mechanical process.

These catalysts may be in the form of powder, chips, pellets, or spheres, etc. The consolidated forms such as pellets and spheres may be preferred, when formed in such a way that the body thereof is not immediately permeable to D₂ gas, and thus the D₂ moves back and forth between the exterior and interior portions less rapidly than through loose powder. This lowered rate of transport seems to extend the time period for chemisorption, and to allow both a higher-temperature exotherm, and a lengthened time for power production. This effect is theoretical, however, and each catalyst composite size and permeability must be optimized empirically.

Similarly, the size and duration of the power-producing exotherm depends in detail on the metal used, the substrate, the metal loading, the pretreatment (frequently a reduction or hydrogenation). Again, the optimum catalyst must be determined empirically.

3. Other Details

The insulated vessel containing the catalyst is not critical to this invention. But it is frequently a dewar-insulated vessel, cylindrical in cross-section, and about as thick as long, so as to maximize volume for surface area. It is traversed by a multitude of steam tubes, spaced a few inches to about one foot apart. These steam tubes are usually in the form of “U” tubes, with the bend approaching the side or end of the vessel. For ease of installation, these “U”-shaped steam tubes are frequently mounted on the cover of the vessel, but that is not essential. It is highly desirable that the insulation be as good as possible, and here it is found that dewar-type construction has a natural maximum operating temperature of about 250° C., because that is the temperature at which the best high-temperature getters top out in utility. However, it is noted that there are satisfactory insulations useful at temperatures of 300°, or even 350 to 400° C., and these would be used when it is desired or necessary to operate the system at such elevated temperatures. And as the size of the catalyst bed, and the heat output, increase, the role of the insulation becomes less important.

The dewar flasks are conveniently made of 18-8 stainless steel, but that is not necessary. The 18-8 is already frequently used in dewar flasks, and takes the temperatures envisioned, and is not affected by hydrogen and deuterium. Mild steel, and other steel alloys, may be used where convenient and proven out. Rarely, it may be desirable to go to the trouble and expense to fabricate the vessel from titanium, which has a very advantageous strength-to-weight ratio and further has the considerable advantage of quite low thermal conductivity. But it is quite more expensive to purchase and fabricate than is 18-8 stainless. Generally, the containers are not large in diameter, so that the ends may be flat or nearly so. However, when vessels of several feet in diameter, and larger, are used, the ends and covers of the vessel may be dished outward, so as to assist in containing the relatively low operating pressures, usually less than 5 atm. absolute in the D₂-absorbing step, and frequently less than 2 atm. absolute, and sometimes near atmospheric.

It has been found that high temperature silicone rubber is a satisfactory gasketing material for the insulating vessel, and gives quite low-to-undetectable leaks with hydrogen and deuterium at near atmospheric pressure. But for long-term use, and absolutely no deuterium leakage, seals such as are used for high-vacuum applications, involving flanges and silicone, or even Viton O-rings, may be indicated.

The deuterium fuel need not be of extremely high purity. Commercial grades of deuterium seem to function well. An impurity level of up to 1% or more of HD seems to give no problems in operation. Nitrogen, up to 1% or more, is of no effect. However, impurities of O₂, H₂O, and CO₂, should be minimized, because they interact with either the catalyst, or the deuterium, or both.

As already described, the operating temperature of the heat-generation step is frequently in the range of 150° to about 250° C. But for maximum exotherm, it is sometimes desirable to operate over 250° C., and up to about 300° C., or even higher, to about 350° 0. And as described above, the heat lost in reheating the catalyst after D₂-absorption is minimized by operating the D₂-absorption step at the same temperature as the heat-generation step. When operating at heat-generation temperatures of greater than about 225° C., the operating pressure for D₂-absorption may necessarily by increased, to 2 atm., or even 5 to 10 atm. Thus, the temperature for heat generation is limited by that maximum temperature for D₂ chemisorption, at whatever absorption pressure is employed.

When the catalyst is in the form of coarse particles, as pellets, spheres, etc., the catalyst may be in one layer in the heat-generation vessel, and may be a layer of several feet thick. But when fine-particle catalyst is used, the catalyst may be used in a multiplicity of relatively thin layers, so as to avoid pressure drop of D₂ across a thick layer of (compacted) fine catalyst.

### EXAMPLE I

The experiment was conducted in a large dewar flask of about 21 liter internal capacity. The flask was constructed of 304 stainless steel, and was about 7 inches in internal diameter, and about 22 inches in internal depth, so it was a long cylinder. The top of the dewar was a flange, also of stainless steel, and about ¼″ thickness, welded to, and forming a seal for, the inner and outer cylinders of the dewar construction. The space between the inner and outer cylinders was filled by winding (rather tightly) alternating layers of porous fiberglas mat, and aluminum foil, indeed the usual construction. A cover was fashioned, also of stainless steel, with a gas inlet-outlet, a thermowell reaching to within about 5 inches of the bottom, and a pressure gauge reading to 30″ vacuum, and 60 pounds per square inch of pressure. A ceramic-sealed electrical lead was positioned in the center of the gas inlet-outlet port. The cover was sealed to the body with a gasket fashioned from high-temperature silicone rubber, and with 6 equally spaced hex-head socket screws.

The construction of the dewar was completed by pulling a vary high vacuum on the annulus between the inner and outer cylinders for nearly one week, and then firing a special high-temperature getter.

The interior of the vessel was fitted with an immersion heater, capable of over 200 watts input, hanging from the cover, and a stainless steel basket hanging below the heater, and also attached to the cover. The immersion heater was electrically connected to the ceramic-sealed lead, and the grounded vessel body.

The basket was filled with 363.5 grams of recovered 0.5% palladium-on-activated catalyst, and 385.1 grams of fresh 0.5% palladium-on-activated catalyst, and the vessel assembled and sealed. The vessel was then filled to about 5 to 10 psi. with H₂ gas, and heated to 175° C., and held at that temperature for a number of hours, to assure complete conditioning of the catalyst.

The vessel was then evacuated, and filled to 14 psi with deuterium gas, and allowed to stand at room temperature for 3 days to load the deuterium into the catalyst.

The vessel was then heated at 2.8 A, and 15.9 V. on the heater for about 36 hours, and reached a stable temperature of about 157.5° C. The vessel was then evacuated to 29 Inches of vacuum, and over a period of 4 to 5 hours, reached a temperature of about 179 to 180° C., some 22° C. higher than before evacuation. This 22° C. represents the exotherm obtained by fusion of deuterium, on evacuation, and amounts to very roughly 10 watts of excess power produced by the fusion.

### EXAMPLE II

The equipment previously used in Example I was again used here.

Here, the catalyst charge was 360 grams of powdered 65% nickel on kieselguhr, being a commercially used nickel hydrogenation catalyst.

The vessel was evacuated, and filled to 14 psi of H₂, and heated with 3.2 A and 18 V. on the heater. Overnight, the temperature reached a stable 179° C. The vessel was then evacuated, filled to 8 psi. of deuterium, allowed to cool, and then stand for 2 days, to load the catalyst with deuterium. On then reheating at about 18 V., and 3.14 A. on the heater, the vessel reached a constant temperature of about 185° C., and on the evacuating to 29 inches of vacuum, the temperature then reached about 201° C. in about 4½ hours.

The temperature exotherm from 179° C. to about 201° C. represented an excess heat production of about 8 watts, or about 10 watts per pound.

### EXAMPLE III

Example II is repeated, here using 400 grams of iron catalyst. This catalyst is manufactured by melting a mixture of natural magnetite, and small amounts of calcium, magnesium, aluminum, and potassium oxides. The cooled melt is then chrushed and sieved. The sieved unreduced catalyst is then reduced with hydrogen, and stabilized by superficial oxidation with air. The analysis of the finished catalyst is 78.0% Fe, 11.0% iron oxides, 3.6% Al₂O₃, 3.2% CaO, 0.8% MgO, 0.7% K₂O, and 0.6% SiO₂.

When a vacuum is pulled on the D₂-loaded catalyst at about 185° C., the exotherm resulting is greater than 5° C.

### EXAMPLE IV

Example II is again repeated, using 400 grams of 67% cobalt on kieselguhr, pelletized, as the catalyst. When a vacuum is pulled on the D₂-loaded catalyst at about 185° C., the resulting exotherm is greater than 5° C.

### EXAMPLE V

Example II is again repeated, using 400 grams of a copper chromite hydrogenation catalyst, having 40% Cu, and 25% Cr, in tablet form. When a vacuum is pulled on the D₂-loaded catalyst at about 185° C., the resulting exotherm is greater than 5°C.

### EXAMPLE VI

Example II is again repeated, using 400 grams of a copper-zinc hydrogenation catalyst, analyzing 33% CuO and 65% ZnO, and in the form of a tablets. When a vacuum is pulled on the D₂-loaded catalyst at 185° C., the resulting exotherm is greater than 5° C.

### EXAMPLE VII

Example II is again repeated, using 400 grams of a chromium-promoted iron oxide catalyst in the form of tablets, and having an analysis of 89% Fe₂O₃, and 9% Cr₂O₃. When a vacuum is pulled on the D₂-loaded catalyst at 185° C., the resulting exotherm is greater than 5° C.

### EXAMPLE VIII

Example II was again repeated, using the same catalyst charge, but starting the pulling of a vacuum at about 190° C., rather than 179° C. On pulling of the vacuum on the D₂-loaded catalyst, the resulting exotherm was a few degrees higher than that obtained in Example II.

I claim:

1. The process of producing energy by fusion of deuterium into helium-4, which comprises loading deuterium gas into a metallic hydrogenation catalyst capable of chemisorbing said deuterium gas at about 150° C., and subsequently degassing said catalyst at a reduced pressure of no more than about 0.25 atm. absolute, and at a temperature of at least about 150° C.

2. The process of claim 1, wherein the said loading and degassing occurs in a sealed, gas-tight, insulated vessel traversed by a multitude of steam tubes.

3. The process of claim 2, wherein the said energy production takes place in a multiplicity of said vessels, and in which at least one vessel is in the heat-production mode, concurrently with at least one vessel being in the deuterium-loading mode.

4. The process of claim 2, wherein the said deuterium gas is commercial-grade deuterium.

5. The process of claim 2, wherein the said deuterium gas is the electrolysis product of commercial-grade heavy water.

6. The process of claim 2, in which the degassing takes place at a pressure less than about 0.1 atm. absolute.

7. The process of claim 2, in which the degassing take place at a pressure less than about 0.05 atm. absolute.

8. The process of claim 2, in which the degassed deuterium gas is directly fed into vessel being loaded with deuterium.

9. The process of claim 2, in which the said catalyst is a platinum-group-metal catalyst.

10. The process of claim 2, in which the said catalyst is about 0.5% Pd on activated carbon.

11. The process of claim 2, in which the said catalyst is a commercial nickel hydrogenation catalyst.

12. The process of claim 2, in which the said catalyst is comprised largely of reduced iron.

13. The process of claim 2, in which the said catalyst is selected from the group consisting of commercial-grade copper, copper-chromite, and cobalt catalysts.

14. The process of claim 2, in which the said catalyst is in the form of powder.

15. The process of claim 2, in which the said catalyst is in the composite form selected from the group consisting of pellets, extrusions, chips, spheres, and the like.

16. The process of claim 2, in which the catalyst is nickel on silica, with a nickel loading of at least about 20%.

17. The process of claim 2, in which the degassing occurs at a temperature of from about 150° C. to about 300° C.

18. The process of claim 2, in which the degassing occurs at a temperature of from about 175° C. to about 250° C.

19. The process of claim 1, in which the heat output of the catalyst in the degassing phase is at least about 10 watts per pound of catalyst.
